(19) United States
(12) Patent Application Publication
(10) Pub. No.: US 2016/0084275 A1
(43) Pub. Date: Mar. 24, 2016

(54) WORK VEHICLE, AND CONTROL METHOD FOR WORK VEHICLE

(71) Applicant: Komatsu Ltd., Tokyo (JP)

(72) Inventors: Shinji Kaneko, Oyama-shi (JP); Yoshitaka Onodera, Hiratsuka-shi (JP); Yoshifumi Shitara, Hiratsuka-shi (JP); Taishi Oiwa, Naka-gun (JP); Jun Hashimoto, Chigasaki-shi (JP)

(21) Appl. No.: 14/416,807

(22) PCT Filed: Sep. 18, 2014
(86) PCT No.: PCT/JP2014/074750

§ 371 Date: Jan. 23, 2015

(51) Int. Cl. F15B 11/042

(52) U.S. Cl. CPC F15B 11/042; F15B 2211/20546

(57) ABSTRACT

A work vehicle including: a traveling hydraulic pump of a variable displacement type driven by engine; a hydraulic motor forming a closed circuit with the traveling hydraulic pump and driven by operating oil discharged from the traveling hydraulic pump; a drive wheel driven by the hydraulic motor; and a control device determining whether an operator of the work vehicle has an intention of decelerating the work vehicle, and when the operator has an intention of decelerating the work vehicle and when the work vehicle starts to increase its speed, the control device causes a capacity ratio obtained by dividing a capacity of the hydraulic motor by a capacity of the traveling hydraulic pump, to be equal to or larger than a value when the work vehicle starts to increase its speed, according to an increasing amount in the speed of the work vehicle.

### FIELD

The present invention relates to a work vehicle including a variable displacement hydraulic pump driven by an engine, and a hydraulic motor that forms a closed circuit with the hydraulic pump and is driven by operating oil discharged from the hydraulic pump, and a control method for a work vehicle.

### BACKGROUND

There is a work vehicle including a hydraulic drive device called an HST (Hydro Static Transmission) mounted between an engine, which is a drive source, and drive wheels. In the HST, a traveling hydraulic pump of a variable displacement type driven by an engine and a hydraulic motor of a variable displacement type driven by operating oil discharged from the traveling hydraulic pump are provided to a main hydraulic circuit that is a closed circuit. The HST allows the vehicle to travel by transmitting driving force of the hydraulic motor to the drive wheels. Some forklifts that are a type of the work vehicle include the HST (for example, Patent Literature 1).

### CITATION LIST

### Patent Literature

Patent Literature 1: Japanese Laid-open Patent Publication No. 2012-057502

### SUMMARY

### Technical Problem

When a work vehicle travels on a downward slope, i.e., when a work vehicle is on a downward slope, the work vehicle is likely to be accelerated due to the gravity force, and its speed is increased by the gravity force, even though an operator does not press an accelerator, for example. Patent Literature 1 has neither description nor suggestion about a phenomenon when a forklift that is a work vehicle is on a downward slope, and has room for improvement.

The present invention aims to suppress an increase in speed when a work vehicle having an HST travels on a downward slope.

### Solution to Problem

According to the present invention, a work vehicle including a work machine, the work vehicle comprises: an engine; a traveling hydraulic pump of a variable displacement type that is driven by the engine; a hydraulic motor that forms a closed circuit with the traveling hydraulic pump and that is driven by operating oil discharged from the traveling hydraulic pump; a drive wheel driven by the hydraulic motor; and a control device that includes a determination unit determining whether or not an operator of the work vehicle has an intention of decelerating the work vehicle, and when the determination unit determines that the operator has an intention of decelerating the work vehicle and when the work vehicle starts to increase a speed of the work vehicle, the control device causes a capacity ratio, which is obtained by dividing a capacity of the hydraulic motor by a capacity of the traveling hydraulic pump, to be equal to or larger than a value at a point when the work vehicle starts to increase the speed of the work vehicle, according to an increasing amount in the speed of the work vehicle.

In the present invention, it is preferable that the control device increases the capacity ratio, when the increasing amount of the speed of the work vehicle increases.

In the present invention, it is preferable that the work vehicle further comprises: an accelerator operation unit that increases or decreases a supply amount of fuel to the engine, wherein when the increasing amount in the speed of the work vehicle is a same, the capacity ratio is increased as an operation amount on the accelerator operation unit is smaller.

In the present invention, it is preferable that the control device determines whether or not the operator of the work vehicle has the intention of decelerating the work vehicle by using: information indicating an advancing direction of the work vehicle selected by a selection switch used for switching a forward direction and a reverse direction of the work vehicle; a discharging pressure of the operating oil supplied to the hydraulic motor from the traveling hydraulic pump; and an inflow pressure of the operating oil flown into the traveling hydraulic pump from the hydraulic motor.

In the present invention, it is preferable that the work vehicle is a forklift.

According to the present invention, a control method for a work vehicle that includes a work machine, an engine, a traveling hydraulic pump of a variable displacement type that is driven by the engine, a hydraulic motor that forms a closed circuit with the traveling hydraulic pump and that is driven by operating oil discharged from the traveling hydraulic pump, and a drive wheel driven by the hydraulic motor, the control method comprises: determining whether or not an operator of the work vehicle has an intention of decelerating the work vehicle; and causing a capacity ratio, which is obtained by dividing a capacity of the hydraulic motor by a capacity of the traveling hydraulic pump, to be equal to or larger than a value at a point when the work vehicle starts to increase a speed of the work vehicle, according to an increasing amount in the speed of the work vehicle, when it is determined that the operator of the work vehicle has an intention of decelerating the work vehicle and when the work vehicle starts to increase the speed of the work vehicle, wherein the capacity ratio is increased when the increasing amount in the speed increases, in case where an increasing amount in the capacity ratio is changed.

In the present invention, it is preferable that the work vehicle includes an accelerator operation unit that increases or decreases a supply amount of fuel to the engine, wherein when the increasing amount in the speed is a same, the capacity ratio is increased as an operation amount on the accelerator operation unit is smaller.

In the present invention, it is preferable that whether or not the operator of the work vehicle has an intention of decelerating the work vehicle is determined by using: information indicating an advancing direction of the work vehicle selected by a selection switch used for switching an advancing direction of the work vehicle; a discharging pressure of the operating oil supplied to the hydraulic motor from the traveling hydraulic pump; and an inflow pressure of the operating oil flown into the traveling hydraulic pump from the hydraulic motor.

The present invention can suppress an increase in speed when a work vehicle having an HST travels on a downward slope.

### BRIEF DESCRIPTION OF DRAWINGS

FIG. 1 is a view illustrating an entire configuration of a forklift according to an embodiment of the present invention.

FIG. 2 is a block diagram illustrating a control system of the forklift illustrated in FIG. 1.

FIG. 3 is a state transition diagram illustrating a change in a state when a forklift traveling on a flatland moves to a downward slope.

FIG. 4 is a control block diagram of a control device.

FIG. 5 is a diagram illustrating a change in an inching rate to an inching operation amount.

FIG. 6 is a diagram illustrating a characteristic line L2 of target absorption torque of a traveling hydraulic pump to an actual engine rotating speed.

FIG. 7 is a conceptual diagram illustrating a table 50 in which an inching rate is set according to an accelerator opening and a speed increasing amount.

FIG. 8 is a state transition diagram illustrating a change in a state when a forklift stopping on a downward slope starts to travel.

FIG. 9 is a flowchart illustrating one example of a downward slope control according to the present embodiment.

FIG. 10 is a conceptual diagram illustrating a table 51 in which an inching rate is set according to an accelerator opening and a speed increasing amount.

### DESCRIPTION OF EMBODIMENT

An Embodiment for embodying the present invention will be described below with reference to the accompanying drawings.

<Forklift>

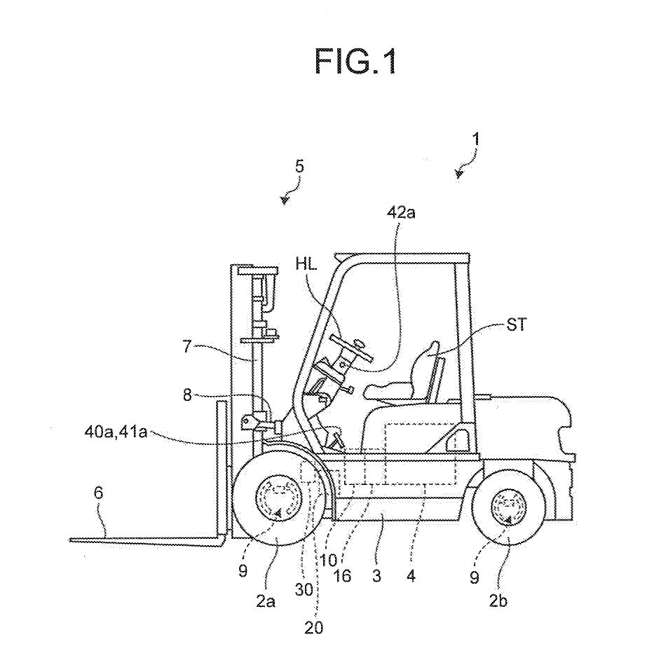

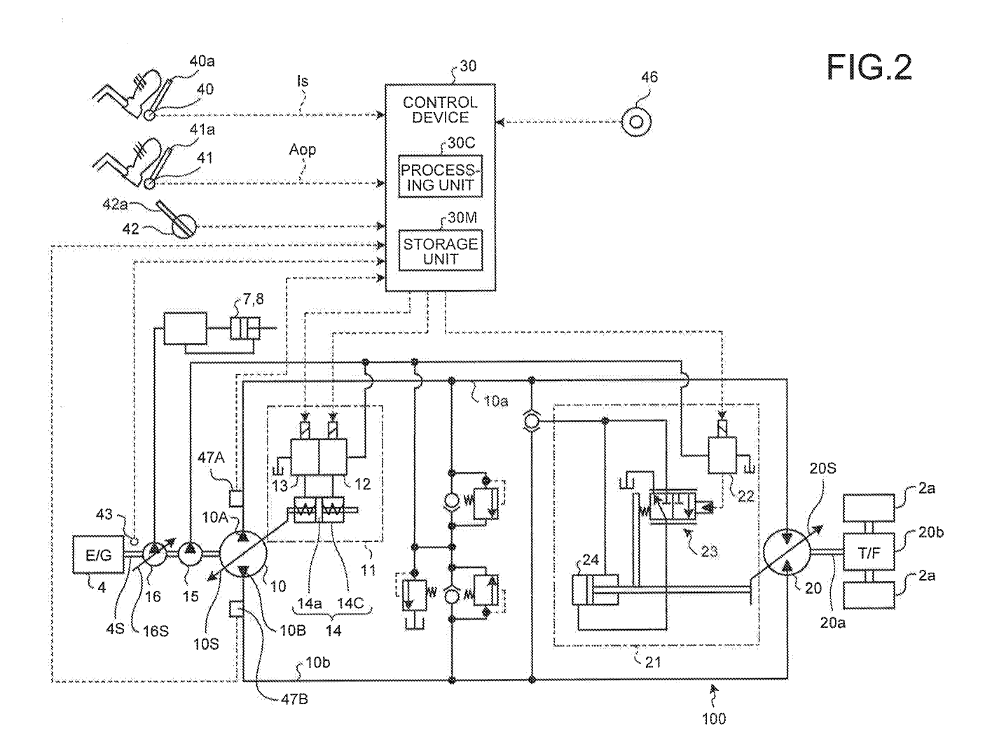

FIG. 1 is a view illustrating an entire configuration of a forklift 1 according to the present embodiment. FIG. 2 is a block diagram illustrating a control system of the forklift illustrated in FIG. 1. The forklift 1 includes a body 3 having drive wheels 2a and steering wheels 2b; a work machine 5; and a mechanical brake 9 that stops the drive wheels 2a and the steering wheels 2b. In the forklift 1, the side from a driver's seat ST to a steering member HL is a front side, while the side from the steering member HL to the driver's seat ST is a back side. The work machine 5 is provided in front of the body 3.

An engine 4 that is one example of an internal combustion engine, a traveling hydraulic pump 10 of a variable displacement type, and a work machine hydraulic pump 16 are mounted on the body 3, the traveling hydraulic pump 10 and the work machine hydraulic pump 16 being driven by using the engine 4 as a drive source. The engine 4 is a diesel engine, for example. However, the engine is not limited thereto. An output shaft 4S of the engine 4 is connected to the traveling hydraulic pump 10 and the work machine hydraulic pump 16. The traveling hydraulic pump 10 and the work machine hydraulic pump 16 are driven by the engine 4 via the output shaft 4S. The drive wheels 2a are communicated with each other by a hydraulic circuit that closes the variable displacement traveling hydraulic pump and a variable displacement hydraulic motor 20. The drive wheels 2a are driven by power from the hydraulic motor 20. In this way, the forklift 1 travels with an HST. In the present embodiment, the traveling hydraulic pump 10 and the work machine hydraulic pump 16 both have a swash plate 10S and a swash plate 16S. Their capacities are changed by changing tilt angles of the swash plates 10S and 16S.

The work machine 5 includes a lift cylinder 7 that moves a fork 6 up and down, and a tilt cylinder 8 that tilts the fork 6. A forward/reverse lever 42a, an inching pedal (brake pedal) 40a serving as an inching operation unit, an accelerator pedal 41a serving as an accelerator operation unit, and an unillustrated work machine operation lever including a lift lever and a tilt lever for operating the work machine 5 are provided on the driver's seat on the body 3. The inching pedal 40a changes an inching rate. The accelerator pedal 41a increases or decreases a supply amount of fuel to the engine 4. The inching pedal 40a and the accelerator pedal 41a are provided at a position where an operator of the forklift 1 can conduct a pedal operation from the driver's seat. FIG. 1 illustrates that the inching pedal 40a and the accelerator pedal 41a are overlapped with each other.

As illustrated in FIG. 2, the forklift 1 includes a main hydraulic circuit 100. The main hydraulic circuit 100 is a closed circuit including the traveling hydraulic pump 10, the hydraulic motor 20, and hydraulic supply conduits 10a and 10b that connect the traveling hydraulic pump 10 and the hydraulic motor 20. The traveling hydraulic pump 10 is a device that is driven by the engine 4 to discharge operating oil. In the present embodiment, the traveling hydraulic pump 10 is a variable displacement pump that can change its capacity by changing a tilt angle of a swash plate, for example.

The hydraulic motor 20 is rotated by the operating oil discharged from the traveling hydraulic pump 10. For example, the hydraulic motor 20 including a swash plate 20S is a variable displacement hydraulic motor that can change its capacity by changing a tilt angle of the swash plate. The hydraulic motor 20 may be a fixed displacement hydraulic motor. An output shaft 20a of the hydraulic motor 20 is connected to the drive wheels 2a via a transfer 20b. The hydraulic motor 20 rotates the drive wheels 2a via the transfer 20b to allow the forklift 1 to travel.

The hydraulic motor 20 can switch the rotating direction according to the supply direction of the operating oil from the traveling hydraulic pump 10. Since the rotating direction of the hydraulic motor 20 is switched, the forklift 1 travels in the forward direction or in the reverse direction. In the description below, it is supposed that the forklift 1 travels in the forward direction when the operating oil is supplied to the hydraulic motor 20 from the hydraulic supply conduit 10a, and the forklift 1 travels in the reverse direction when the operating oil is supplied to the hydraulic motor 20 from the hydraulic supply conduit 10b, for the sake of convenience.

In the traveling hydraulic pump 10, the portion connected to the hydraulic supply conduit 10a is an A port 10A, and the portion connected to the hydraulic supply conduit 10b is a B port 10B. Upon the movement of the forklift 1 in the forward direction, the operating oil is discharged from the A port 10A, and is flown into the B port 10B. Upon the movement of the forklift 1 in the reverse direction, the operating oil is flown into the A port 10A, and is discharged from the B port 10B.

The forklift 1 includes a pump capacity setting unit 11, a motor capacity setting unit 21, and a charge pump 15. The pump capacity setting unit 11 is provided in the traveling hydraulic pump 10. The pump capacity setting unit 11 includes a forward pump solenoid proportional control valve 12, a reverse pump solenoid proportional control valve 13, and a pump capacity control cylinder 14. The forward pump solenoid proportional control valve 12 and the reverse pump solenoid proportional control valve 13 in the pump capacity setting unit 11 receive an instruction signal from a later-described control device 30. In the pump capacity setting unit 11, the pump capacity control cylinder 14 operates according to the instruction signal supplied from the control device 30 to change the tilt angle of the swash plate of the traveling hydraulic pump 10, whereby the capacity of the traveling hydraulic pump 10 is changed.

The pump capacity control cylinder 14 has a piston 14a stored in a cylinder case 14C. The piston 14a reciprocates in the cylinder case 14C by the supply of the operating oil in a space between the cylinder case 14C and the piston 14a. In the pump capacity control cylinder 14, the piston 14a is held at a neutral position when the tilt angle of the swash plate is 0. Therefore, even when the engine 4 rotates, the amount of the operating oil discharged to the hydraulic supply conduit 10a or the hydraulic supply conduit 10b in the main hydraulic circuit 100 from the traveling hydraulic pump 10 is 0.

It is supposed that an instruction signal to increase the capacity of the traveling hydraulic pump 10 is supplied to the forward pump solenoid proportional control valve 12 from the control device 30 from the state where the tilt angle of the swash plate of the traveling hydraulic pump 10 is 0, for example. In this case, the forward pump solenoid proportional control valve 12 applies a pump control pressure to the pump capacity control cylinder 14 according to this instruction signal. As a result, the piston 14a moves to the left in FIG. 2. When the piston 14a in the pump capacity control cylinder 14 moves to the left in FIG. 2, the swash plate 10S of the traveling hydraulic pump 10 tilts toward the direction of discharging the operating oil to the hydraulic supply conduit 10a in response to this motion.

As the pump control pressure from the forward pump solenoid proportional control valve 12 increases, the moving amount of the piston 14a increases. Therefore, the amount of change in the tilt angle of the swash plate 10S in the traveling hydraulic pump 10 also increases. Specifically, when the instruction signal is supplied to the forward pump solenoid proportional control valve 12 from the control device 30, the pump control pressure based on this instruction signal is applied to the pump capacity control cylinder 14 from the forward pump solenoid proportional control valve 12. When the pump capacity control cylinder 14 operates by the above pump control pressure, the swash plate 10S in the traveling hydraulic pump 10 tilts so as to be capable of discharging a predetermined amount of operating oil to the hydraulic supply conduit 10a. Thus, if the engine 4 rotates, the operating oil is discharged from the traveling hydraulic pump 10 to the hydraulic supply conduit 10a, whereby the hydraulic motor 20 rotates in the forward direction.

When an instruction signal to decrease the capacity of the traveling hydraulic pump 10 is supplied to the forward pump solenoid proportional control valve 12 from the control device 30 from the above-mentioned state, the pump control pressure applied to the pump capacity control cylinder 14 from the forward pump solenoid proportional control valve 12 decreases in response to this instruction signal. Therefore, the piston 14a in the pump capacity control cylinder 14 moves to the neutral position. As a result, the tilt angle of the swash plate in the traveling hydraulic pump 10 decreases, so that the discharging amount of the operating oil from the traveling hydraulic pump 10 to the hydraulic supply conduit 10a decreases.

When the control device 30 supplies an instruction signal to increase the capacity of the traveling hydraulic pump 10 to the reverse pump solenoid proportional control valve 13, the reverse pump solenoid proportional control valve 13 applies a pump control pressure to the pump capacity control cylinder 14 in response to this instruction signal. Therefore, the piston 14a moves to the right in FIG. 2. When the piston 14a in the pump capacity control cylinder 14 moves to the right in FIG. 2, the swash plate 10S of the traveling hydraulic pump tilts toward the direction of discharging the operating oil to the hydraulic supply conduit 10b in response to this motion.

As the pump control pressure from the reverse pump solenoid proportional control valve 13 increases, the moving amount of the piston 14a increases. Therefore, the amount of change in the tilt angle of the swash plate in the traveling hydraulic pump 10 also increases. Specifically, when the instruction signal is supplied to the reverse pump solenoid proportional control valve 13 from the control device 30, the pump control pressure based on this instruction signal is applied to the pump capacity control cylinder 14 from the reverse pump solenoid proportional control valve 13. When the pump capacity control cylinder 14 operates by the above pump control pressure, the swash plate 10S in the traveling hydraulic pump 10 tilts so as to be capable of discharging a predetermined amount of operating oil to the hydraulic supply conduit 10b. Thus, if the engine 4 rotates, the operating oil is discharged from the traveling hydraulic pump 10 to the hydraulic supply conduit 10b, whereby the hydraulic motor 20 rotates in the reverse direction.

When an instruction signal to decrease the capacity of the traveling hydraulic pump 10 is supplied to the reverse pump solenoid proportional control valve 13 from the control device 30, the pump control pressure applied to the pump capacity control cylinder 14 from the reverse pump solenoid proportional control valve 13 decreases in response to this instruction signal. Therefore, the piston 14a moves to the neutral position. As a result, the tilt angle of the swash plate in the traveling hydraulic pump 10 decreases, so that the discharging amount of the operating oil from the traveling hydraulic pump 10 to the hydraulic supply conduit 10b decreases.

The motor capacity setting unit 21 is provided on the hydraulic motor 20. The motor capacity setting unit 21 includes a motor solenoid proportional control valve 22, a motor cylinder control valve 23, and a motor capacity control cylinder 24. When an instruction signal is supplied from the control device 30 to the motor solenoid proportional control valve 22 in the motor capacity setting unit 21, a motor control pressure is applied to the motor cylinder control valve 23 from the motor solenoid proportional control valve 22, whereby the motor capacity control cylinder 24 operates. When the motor capacity control cylinder 24 operates, the tilt angle of the swash plate in the hydraulic motor 20 is changed in response to the motion of the motor capacity control cylinder 24. Therefore, the capacity of the hydraulic motor 20 is changed in response to the instruction signal from the control device 30. Specifically, the tilt angle of the swash plate in the hydraulic motor 20 decreases, as the motor control pressure applied from the motor solenoid proportional control valve 22 in the motor capacity setting unit 21 increases.

The charge pump 15 is driven by the engine 4. The charge pump 15 applies the pump control pressure to the pump capacity control cylinder 14 via the forward pump solenoid proportional control valve 12 and the reverse pump solenoid proportional control valve 13. The charge pump 15 has a function of applying the motor control pressure to the motor cylinder control valve 23 via the motor solenoid proportional control valve 22.

In the present embodiment, the engine 4 drives the work machine hydraulic pump 16 as well as the traveling hydraulic pump 10. The work machine hydraulic pump 16 supplies operating oil to the lift cylinder 7 and the tilt cylinder 8, which are working actuators for driving the work machine 5.

The forklift 1 includes an inching potentiometer (brake potentiometer) 40, an accelerator potentiometer 41, a forward/reverse lever switch 42, an engine rotation sensor 43, a speed sensor 46, and pressure sensors 47A and 47B.

When the inching pedal (brake pedal) 40a is operated, the inching potentiometer 40 detects its operation amount and outputs the detected amount. The operation amount of the inching pedal 40a is an inching operation amount Is. The inching operation amount Is outputted from the inching potentiometer 40 is inputted to the control device 30.

When the accelerator pedal 41a is operated, the accelerator potentiometer 41 outputs an operation amount Aop of the accelerator pedal 41a. The operation amount Aop of the accelerator pedal 41a is also referred to as an accelerator opening Aop. The accelerator opening Aop outputted from the accelerator potentiometer 41 is inputted to the control device 30.

The forward/reverse lever switch 42 is a selection switch for switching the advancing direction of the forklift 1. The present embodiment employs the forward/reverse lever switch 42 including a forward/reverse lever 42a provided at the position where a driver can conduct a selecting operation from the driver's seat. The driver operates the forward/reverse lever 42a to select any one of three directions, which are the forward direction, the neutral position, and the reverse direction, thereby being capable of switching the direction of the forklift 1 between the forward direction and the reverse direction. Information indicating the advancing direction of the forklift 1 selected by the forward/reverse lever switch 42 is supplied to the control device 30 as selection information. The advancing direction of the forklift 1 selected by the forward/reverse lever switch 42 includes both the direction in which the forklift 1 is to travel and the direction in which the forklift 1 is now traveling.

The engine rotation sensor 43 detects an actual rotating speed of the engine 4. The rotating speed of the engine 4 detected by the engine rotation sensor 43 is an actual engine rotating speed Nr. Information indicating the actual engine rotating speed Nr is inputted to the control device 30. The rotating speed of the engine 4 is a rotating speed of the output shaft 4S of the engine 4 per a unit time. The speed sensor 46 is a device detecting a traveling speed of the forklift 1, i.e., an actual speed Vc.

The pressure sensor 47A is provided to the hydraulic supply conduit 10a to detect the pressure of the operating oil in the hydraulic supply conduit 10a. The pressure sensor 47B is provided to the hydraulic supply conduit 10b to detect the pressure of the operating oil in the hydraulic supply conduit 10b. The control device 30 acquires the detection values of the pressure sensors 47A and 47B, and uses the acquired values for a control method for a work vehicle according to the present embodiment.

The control device 30 includes a processing unit 30C and a storage unit 30M. For example, the control device 30 is a device including a computer to execute various processes involved with the control of the forklift 1. The processing unit 30C is a device including a CPU (Central Processing Unit) and a memory in combination with each other. The processing unit 30C reads a computer program that is stored in the storage unit 30M for controlling the main hydraulic circuit 100, and executes a command written on this program to control the operation of the main hydraulic circuit 100. The storage unit 30M stores the above-mentioned computer program and data necessary for the control of the main hydraulic circuit 100. The storage unit 30M is a ROM (Read Only Memory), a storage device, or a device including a ROM and a storage device in combination.

Various sensors, such as the inching potentiometer 40, the accelerator potentiometer 41, the forward/reverse lever switch 42, the engine rotation sensor 43, the speed sensor 46, and the pressure sensors 47A and 47B, are electrically connected to the control device 30. The control device 30 generates instruction signals for the forward pump solenoid proportional control valve 12 and the reverse pump solenoid proportional control valve 13 based on the input signals from these various sensors, and supplies the generated instruction signals to the respective solenoid proportional control valves 12, 13, and 22.

<Control when Forklift 1 Traveling on Flatland Moves to Downward Slope>

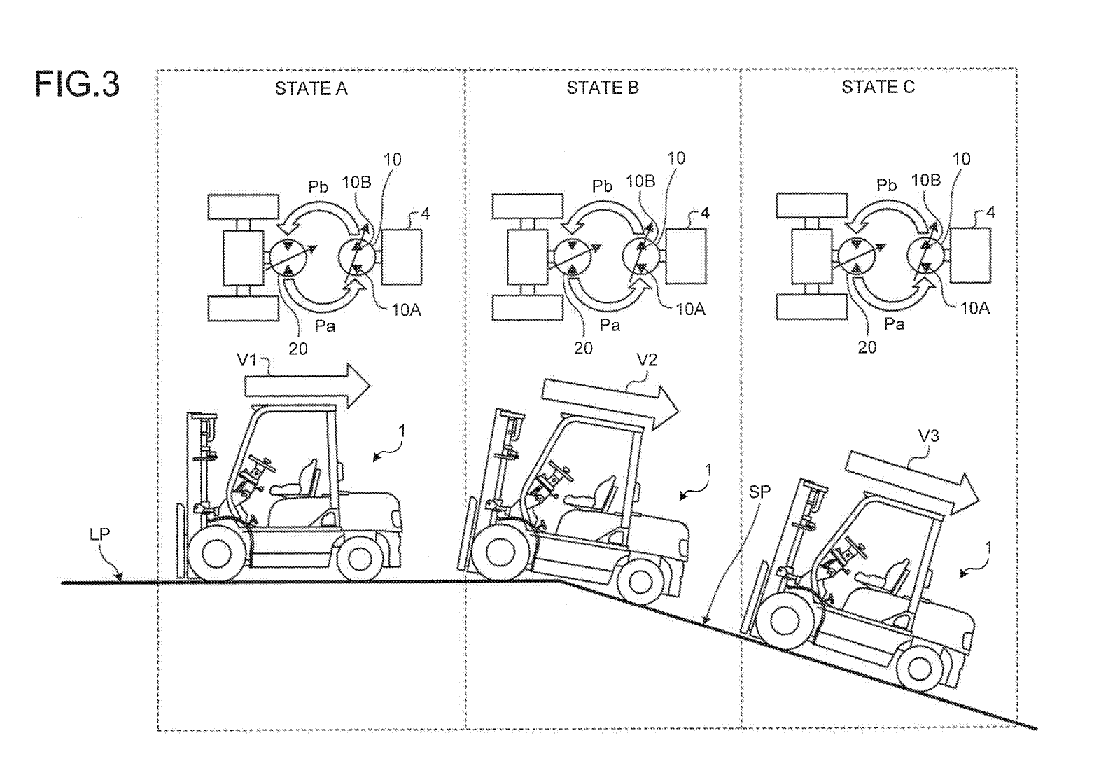

FIG. 3 is a state transition diagram illustrating a change in a state in which the forklift 1 traveling on a flatland moves to a downward slope. FIG. 3 illustrates a state A, a state B, and a state C. The state A indicates that the forklift 1 travels in the reverse direction on a flatland LP, the state B indicates that the forklift 1 moves to a downward slope SP from the flatland LP, and the state C indicates that the forklift 1 travels in the reverse direction on the downward slope SP. When the forklift 1 in the state A in which the forklift 1 travels in the reverse direction on the flatland LP with a speed V1 moves to the downward slope SP indicated by the state B, the traveling speed of the forklift 1 increases to V2 from V1.

As indicated by the state A, when the forklift 1 travels in the reverse direction on the flatland LP, the operating oil is discharged to the hydraulic motor 20 from the B port 10B in the traveling hydraulic pump 10, and the operating oil from the hydraulic motor 20 is flown into the A port 10A in the traveling hydraulic pump 10. When the forklift 1 travels in the reverse direction on the flatland with the opening of the accelerator pedal 41a illustrated in FIG. 2 being constant, i.e., with the accelerator opening being constant, traveling resistance is generated. Therefore, the pressure Pb of the operating oil in the B port 10B from which the operating oil is discharged becomes greater than the pressure Pa of the operating oil in the A port 10A into which the operating oil is flown (Pb>Pa).

When the forklift 1 enters the downward slope SP with the accelerator opening being constant as illustrated in the state B, the traveling power on the downward slope SP becomes greater than the traveling resistance due to the weight of the forklift 1. Therefore, the traveling speed of the forklift 1 increases to the speed V2 from the speed V1. Accordingly, when the forklift 1 travels in the reverse direction on the downward slope SP with the accelerator opening being constant, the pressure Pa of the operating oil in the A port 10A into which the operating oil is flown becomes greater than the pressure Pb of the operating oil in the B port 10B from which the operating oil is discharged (Pa>Pb).

When the forklift 1 travels on the downward slope SP with the constant accelerator opening, the traveling speed of the forklift 1 gradually increases due to the weight of the forklift 1 and the gravity force. In the case where the accelerator opening is constant, it can be determined that the operator of the forklift 1 has no intention of at least increasing the speed of the forklift 1. Therefore, the situation in which the traveling speed of the forklift 1 increases in such case is against the operator's intention.

In the present embodiment, when the forklift 1 starts to travel on the downward slope SP, i.e., when the traveling speed of the forklift 1 increases against the intention of the operator on the forklift 1 to reduce the speed of the forklift 1, a capacity ratio Rq=Qm/Qp obtained by dividing the capacity Qm of the hydraulic motor by the capacity Qp of the traveling hydraulic pump 10 is changed depending upon the increasing amount in the traveling speed. Specifically, the capacity ratio Rq in the case where the forklift 1 is now traveling on the downward slope SP is set to be equal to or greater than the capacity ratio Rq at the point when the forklift 1 starts to travel on the downward slope SP. In the present embodiment, the capacity ratio Rq is changed by changing the inching rate. The inching rate will be described later.

The state C indicates the state in which the forklift 1 is now traveling on the downward slope SP, wherein the traveling speed V3 of the forklift 1 becomes greater than the speed V2 at the point when the forklift 1 starts to travel on the downward slope SP. In this case, the capacity ratio Rq is set to be equal to or greater than the ratio at the point when the forklift 1 starts to travel on the downward slope SP. With the change in the capacity ratio Rq as described above, the capacity of the traveling hydraulic pump 10 relatively decreases, while the capacity of the hydraulic motor 20 relatively increases, whereby the braking force by the engine 4 increases.

Specifically, the flow rate of the operating oil supplied to the traveling hydraulic pump 10 from the hydraulic motor 20 increases, whereby the traveling hydraulic pump 10 becomes a resistance. With this, the pressure of the operating oil present in a pipe Pa at the inlet of the traveling hydraulic pump 10 increases to generate braking force on the hydraulic motor 20. When the capacity of the traveling hydraulic pump 10 decreases, and the flow rate of the operating oil flown into the hydraulic motor 20 increases, the rotating speed of the engine 4 increases. As a result, the discharge resistance, intake resistance, and sliding resistance of the engine 4 increase, whereby the braking force by the engine 4 increases. The increase in the traveling speed of the forklift 1 that is traveling on the downward slope is suppressed due to these actions, whereby the motion of the forklift 1 against the operator's intention can be prevented.

<Control Block of Control Device 30>

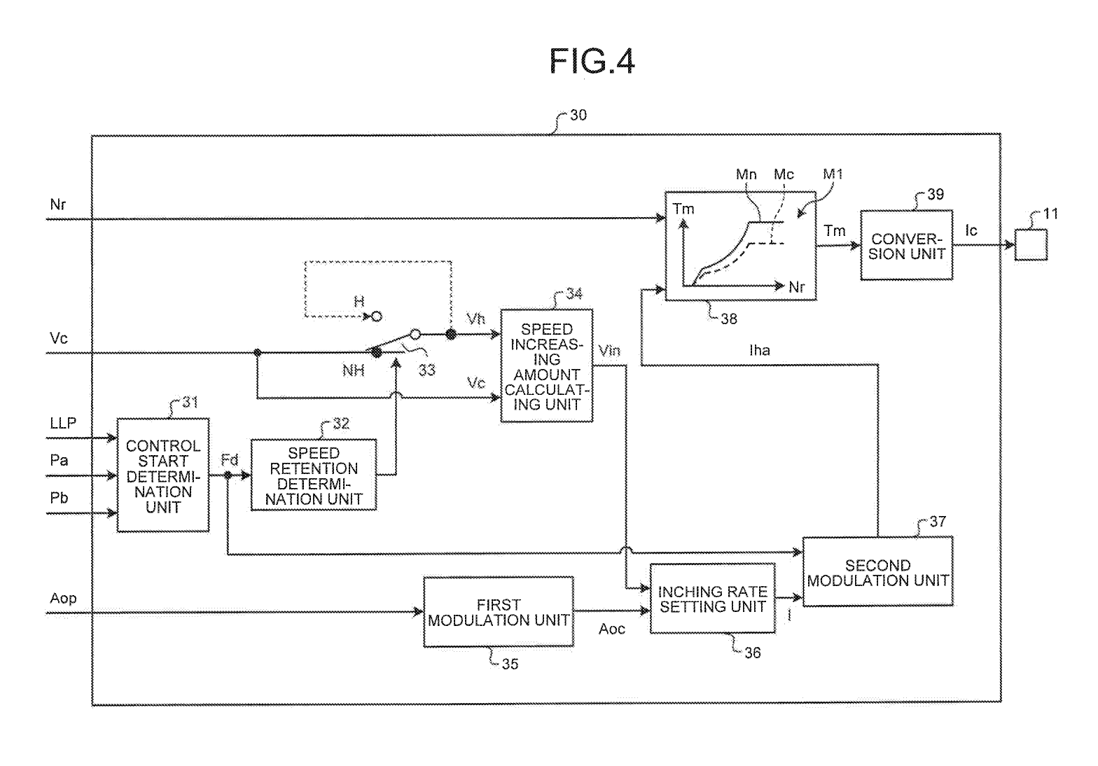

FIG. 4 is a control block diagram of the control device 30. In the description below, the traveling speed of the forklift 1 is referred to as a speed as necessary, and is represented by a reference sign Vc. As illustrated in FIG. 4, the control device 30 includes a control start determination unit 31, a speed retention determination unit 32, a speed retaining unit 33, a speed increasing amount calculating unit 34, a first modulation unit 35, an inching rate setting unit 36, and a second modulation unit 37. The control device 30 executes the control method for a work vehicle according to the present embodiment to inhibit the increase in speed of the forklift 1 due to the influence of the gravity force, when the forklift 1 travels down a slope. In the description below, the control method for a work vehicle according to the present embodiment is referred to as a downward slope control as necessary.

The control start determination unit 31 is a determination unit determining whether or not the operator of the forklift 1 has an intention of decreasing the speed of the forklift 1. The pressure of the operating oil at the A port 10A illustrated in FIG. 2 is defined as Pa, while the pressure of the operating oil at the B port 10B is defined as Pb. The control start determination unit 31 determines whether or not the forklift 1 now generates deceleration force based on the pressure Pa of the operating oil at the A port 10A, the pressure Pb of the operating oil at the B port 10B, and an output LLP of the forward/reverse lever switch 42. The output LLP of the forward/reverse lever switch 42 is information indicating whether the advancing direction of the forklift 1 is a forward direction or a reverse direction. As described above, the control start determination unit 31 determines whether or not the forklift 1 now generates the deceleration force based on the information indicating the advancing direction of the forklift 1 selected by the forward/reverse lever switch 42, the discharging pressure of the operating oil supplied to the hydraulic motor 20 from the traveling hydraulic pump 10, and the inflow pressure of the operating oil flown into the traveling hydraulic pump 10 from the hydraulic motor 20.

When either one of a condition (a) and a condition (b) is established, the control start determination unit 31 determines that the operator of the forklift has an intention of decelerating the forklift, and sets a now control flag Fd to 1. The time when the now control flag Fd is 1 is the start of the deceleration of the forklift 1. When neither the condition (a) nor the condition (b) is established, the control start determination unit 31 determines that the operator of the forklift has no intention of decelerating the forklift, and sets the now control flag Fd to 0. The condition (a) is for determining the case where the forklift 1 tries to decelerate while it is traveling in the forward direction, and the condition (b) is for determining the case where the forklift 1 tries to decelerate while it is traveling in the reverse direction.

In the case of the now control flag Fd=1, the control device 30 executes the downward slope control, and in the case of the now control flag Fd=0, the control device 30 does not execute the downward slope control. The determination result of the control start determination unit 31 is outputted to the speed retention determination unit 32 and the second modulation unit 37. A pressure Pct in the condition (a) and the condition (b) is a constant, and it is 30 kg/cm² in the present embodiment, for example. However, the pressure Pct is not limited thereto.

Condition (a): The forward/reverse lever switch 42 outputs a forward direction, and Pa<Pb−Pct

Condition (b): The forward/reverse lever switch 42 outputs a reverse direction, and Pa−Pct>Pb

In the case of the now control flag Fd=1, the control device 30 executes the downward slope control. Therefore, in the case of the now control flag Fd=1, the speed retention determination unit 32 determines that the speed of the forklift 1 at the point when the now control flag Fd becomes 1 is retained, and allows the speed retaining unit 33 to retain the speed at the point when the now control flag Fd becomes 1. In the case of the now control flag Fd=0, the control device 30 does not execute the downward slope control. Therefore, the speed retention determination unit 32 does not allow the speed retaining unit 33 to retain the speed of the forklift 1.

The speed retaining unit 33 retains the speed Vc at the point when the now control flag Fd becomes 1 according to the instruction from the speed retention determination unit 32. In the present embodiment, when receiving the instruction from the speed retention determination unit 32, the speed retaining unit 33 switches to a retaining state (H) from a non-retaining state (NH), thereby retaining the speed Vc at the point when the now control flag Fd becomes 1. The retained speed Vc is referred to as a retained speed Vh. The retention of the speed is canceled when the now control flag Fd becomes 0.

The speed increasing amount calculating unit 34 calculates, from an equation (1), an increasing amount of the speed (hereinafter referred to as a speed increasing amount) Vin of the forklift 1 in the case where the operator has the intention of decelerating the forklift. Vc is the actual speed of the forklift 1, and Vh is a retained speed. Specifically, the speed increasing amount Vin is a difference between the actual speed Vc and the retained speed Vh. The speed increasing amount calculating unit 34 outputs the speed increasing amount Vin to the inching rate setting unit 36.

Vin=Vc−Vh (1)

The first modulation unit 35 outputs a corrected accelerator opening Aoc, which is obtained by modulating the accelerator opening Aop, to the inching rate setting unit 36. The first modulation unit 35 changes the responsiveness of the traveling hydraulic pump 10 to the operation amount of the accelerator pedal 41a, thereby inhibiting a rapid acceleration of the forklift 1 caused by an excessive pressing operation on the accelerator pedal 41a.

In order to obtain the corrected accelerator opening Aoc, the first modulation unit 35 sets a cutoff frequency f of the accelerator opening Aop, and outputs the value delayed according to this cutoff frequency f as the corrected accelerator opening Aoc. In the present embodiment, the process of delaying the accelerator opening Aop according to the set cutoff frequency f is referred to as a correction of the accelerator opening Aop. The cutoff frequency f can be obtained from an equation (2). T is a time constant of a primary delay element. As understood from the equation (2), the cutoff frequency f is an inverse of the time constant τ.

f=1/(2×π×τ) (2)

The input to the first modulation unit 35 is defined as the accelerator opening Aop, and the output is defined as the corrected accelerator opening Aoc. When the output to the input to the first modulation unit 35 complies with the primary delay, the relationship between the accelerator opening Aop that is the input and the corrected accelerator opening Aoc that is the output is as represented by an equation (3). An equation (4) can be obtained from the equation (3). Aocb in the equation (4) indicates a corrected accelerator opening Aoc outputted from the first modulation unit 35 before the corrected accelerator opening Aoc, which is the output from the first modulation unit 35 at the present time, by a time Δt.

Aoc+τ×dAoc/dt=Aop (3)

Aoc+(Aoc−Aocb)×T/Δt=Aop (4)

When the equation (4) is solved with respect to the corrected accelerator opening Aoc, an equation (5) is obtained. From the equation (5), the corrected accelerator opening Aoc is represented by the relationship among the accelerator opening Aop inputted to the first modulation unit 35 at the present time, the corrected accelerator opening Aocb outputted from the first modulation unit 35 before the present time by the time Δt, the time constant τ, and the time Δt. The time Δt can be a period required for one control cycle, for example. The corrected accelerator opening Aocb can be the corrected accelerator opening Aoc outputted from the first modulation unit 35 in the last control cycle. The time constant τ is set beforehand. The accelerator opening Aop is the accelerator opening Aop outputted from the accelerator potentiometer 41 at the present time. From the equation (2), the time constant τ is represented as T=1/(2×n×f) by using the cutoff frequency f. Therefore, the equation (5) can be an equation (6) by using the cutoff frequency f.

Aoc=Aop×Δt/(Δt+r)+Aocb×τ/(Δt+τ) (5)

Aoc=Aop×2×π×f×Δt/(2×π×f×Δt+1)+Aocb/(2×π×f×Δt+1) (6)

The first modulation unit 35 delays the inputted accelerator opening Aop, and outputs the resultant as the corrected accelerator opening Aoc. The degree of the delay is set depending on the cutoff frequency f or the time constant τ. In the present embodiment, the modulation set value described above is the cutoff frequency f or the time constant τ. The degree of the delay decreases by increasing the cutoff frequency f (decreasing the time constant r), while the degree of the delay increases by decreasing the cutoff frequency f (increasing the time constant τ). The first modulation unit 35 can change the responsiveness (hereinafter referred to as an accelerator responsiveness as necessary) of the traveling hydraulic pump 10 to the operation on the accelerator pedal 41a by changing the degree of the delay of the inputted accelerator opening Aop.

In the present embodiment, the first modulation unit 35 allows the cutoff frequency f upon the pressing operation on the accelerator pedal 41a, i.e., upon the increase in the accelerator opening Aop, to be smaller than the cutoff frequency f upon the release of the accelerator pedal 41a, i.e., upon the decrease in the accelerator opening Aop. With this operation, the accelerator responsiveness upon increasing the accelerator opening Aop becomes smaller than the accelerator responsiveness upon decreasing the accelerator opening Aop, whereby the rapid acceleration of the forklift 1 caused by the excessive pressing operation on the accelerator pedal 41a is prevented.

The inching rate setting unit 36 changes the capacity ratio Rq by changing the inching rate I with the speed increasing amount Vin. The inching rate I obtained by the inching rate setting unit 36 is outputted to the second modulation unit 37.

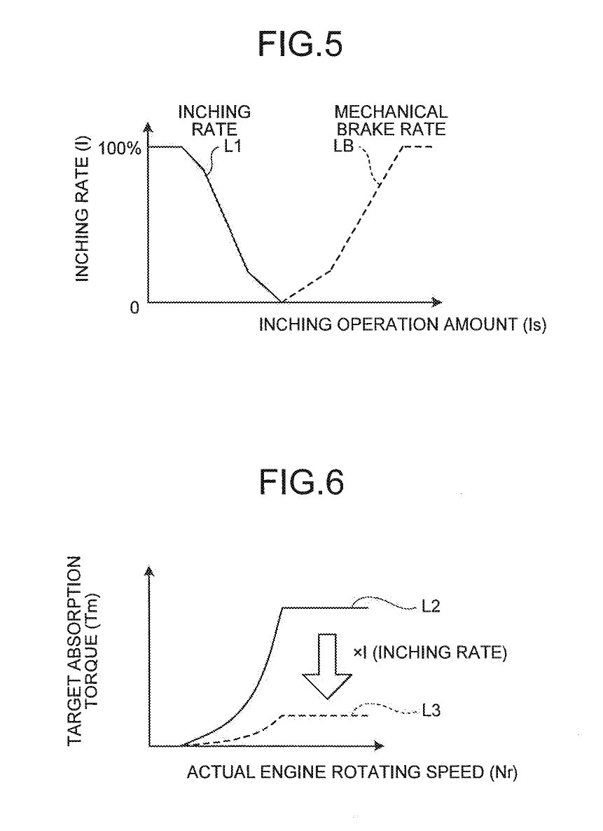

FIG. 5 is a diagram illustrating the change in the inching rate I to the inching operation amount Is. A vertical axis in FIG. 5 is the inching rate I, and a horizontal axis is the inching operation amount Is. The inching rate I indicates a reduction rate of the traveling hydraulic pump 10 to a certain tilt angle of the swash plate, and it can also be described as a reduction rate in the target absorption torque of the traveling hydraulic pump 10. When the inching rate I is 100%, the driving force of the engine 4 is all transmitted to the traveling hydraulic pump 10, and when the inching rate I is 0%, the driving force of the engine 4 is not transmitted to the traveling hydraulic pump 10.

It is supposed that the inching rate I is changed to 50% from 100%. When the inching rate I is changed to 50% from 100%, the tilt angle of the swash plate in the traveling hydraulic pump 10 becomes smaller than the tilt angle of the case where the inching rate I is 100%. As a result, the capacity of the traveling hydraulic pump 10 in the case where the inching rate I is 50% becomes smaller than the capacity in the case where the inching rate I is 100%, whereby the capacity ratio Rq in the case where the inching rate I is 50% becomes greater than the capacity ratio Rq in the case where the inching rate I is 100%. In this way, the capacity ratio Rq can be changed by changing the inching rate I.

In the present embodiment, the inching rate I is changed to 0% from 100% within the range where the inching operation amount Is detected by the inching potentiometer is from 0% to 50%, as indicated by a characteristic line L1 in FIG. 5, for example. As indicated by a characteristic line LB, a mechanical brake rate indicating how much braking force is applied by the mechanical brake 9 illustrated in FIG. 1 is changed to 100% from 0% within the rage where the inching operation amount Is is from 50% to 100%.

FIG. 6 is a diagram illustrating a characteristic line L2 of the target absorption torque Tm of the traveling hydraulic pump 10 to the actual engine rotating speed Nr. FIG. 6 illustrates that the characteristic line L2 is changed to a characteristic line L3 by multiplying the characteristic line L2 by the inching rate I. Specifically, the target absorption torque Tm of the traveling hydraulic pump 10 decreases by the decrease in the inching rate I. As described above, the inching rate I corresponds to the decrease rate of the target absorption torque Tm of the traveling hydraulic pump 10.

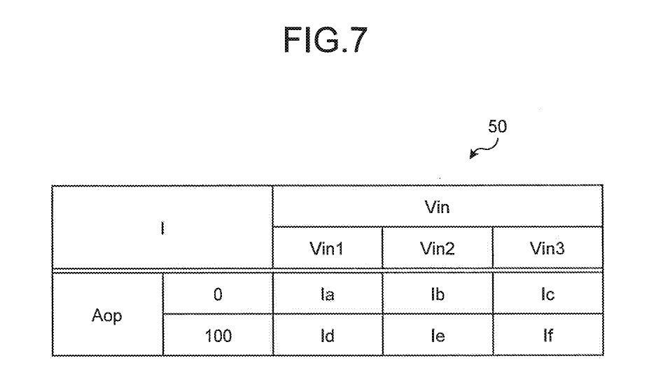

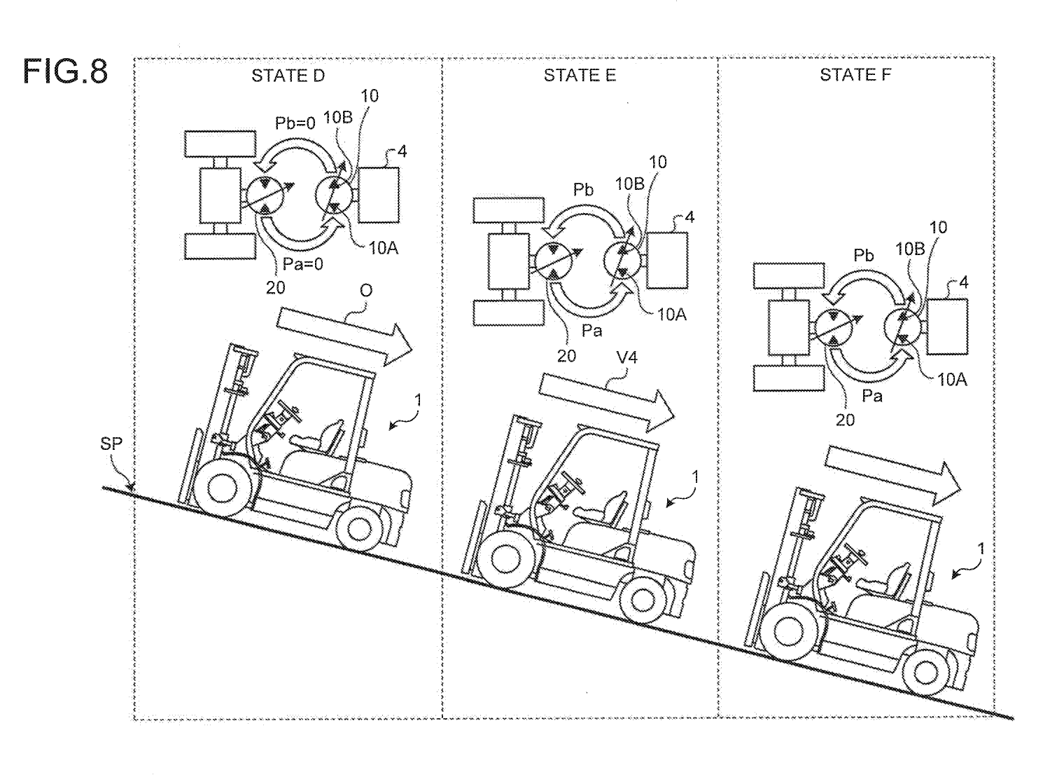

FIG. 7 is a conceptual diagram illustrating a table 50 in which the inching rate I is set according to the accelerator opening Aop and the speed increasing amount Vin. The inching rate setting unit 36 supplies the corrected accelerator opening Aoc inputted from the first modulation unit 35, i.e., the modulated accelerator opening Aop, and the speed increasing amount Vin inputted from the speed increasing amount calculating unit 34 to the table 50, to obtain the inching rate I. In the table 50, an inching rate I is set for each of plural speed increasing amounts Vin1, Vin2, and Vin3 for each of the case where the accelerator opening Aop is 0% and the case where the accelerator opening Aop is 100%. The table 50 is stored in the storage unit 30M in the control device 30 illustrated in FIG. 2.

The speed increasing amounts Vin1, Vin2, and Vin3 increase in this order. Specifically, Vin1<Vin2<Vin3 is established. The inching rate I in the case where the accelerator opening Aop is 0% is set as Ia for the speed increasing amount Vin1, Ib for the speed increasing amount Vin2, and Ic for the speed increasing amount Vin3. The inching rates Ia, Tb, and Ic decrease in this order. Specifically, Ia>Ib>Ic is established. The inching rate I in the case where the accelerator opening Aop is 100% is set as Id for the speed increasing amount Vin1, Ie for the speed increasing amount Vin2, and If for the speed increasing amount Vin3. The inching rates Id, Ie, and If decrease in this order. Specifically, Id>Ie>If is established. The capacity ratio Rq increases, as the inching rate I decreases. As described above, when the speed increasing amount Vin increases, the inching rate I decreases, and the capacity ratio Rq increases, in the present embodiment. With this control, stronger braking force is generated on the forklift 1, as the speed increasing amount Vin is larger, whereby the rapid increase in the speed Vc of the forklift 1 can surely be prevented.

The inching rate I satisfies Ta=Id, Ib<Te, and Ic<If. Ia<Id may also be established. Specifically, when the case of 0% of the accelerator opening Aop and the case of 100% of the accelerator opening Aop are compared, the inching rate I is smaller and the capacity ratio Rq is greater in the case where the accelerator opening Aop is smaller, if the speed increasing amount Vin is the same. With this control, stronger braking force is generated on the forklift 1, as the accelerator opening Aop is smaller. As the accelerator opening Aop is smaller, it is considered that the operator of the forklift 1 does not intend to accelerate the forklift 1. As the accelerator opening Aop is smaller, stronger braking force is applied to the forklift 1, whereby the forklift 1 can travel according to the operator's intention. When the accelerator opening Aop is great, it is considered that the operator has the intention of accelerating the forklift 1. As the accelerator opening Aop is great, the braking force generated on the forklift 1 on which the deceleration force is now applied decreases, whereby the forklift 1 can travel according to the operator's intention of accelerating the forklift 1.

In the table 50, the accelerator opening Aop and the speed increasing amount Vin are discretely set. The processing unit 30C can obtain an inching rate I within the range where the accelerator opening Aop and the speed increasing amount Vin are not present by performing interpolation by use of the inching rate I within the range where the accelerator opening Aop and the speed increasing amount Vin are present, for example. The number of the inching rates I set in the table 50 is not limited to the number in the present embodiment.

The second modulation unit 37 outputs a corrected inching rate Iha obtained by modulating the inching rate I inputted from the inching rate setting unit 36. The control device 30 changes the tilt angle of the swash plate in the traveling hydraulic pump 10 by using the corrected inching rate Iha. The corrected inching rate Iha can be obtained from an equation (7) by using the time constant r, and can be obtained from an equation (8) by using the cutoff frequency f. The relationship between the time constant t and the cutoff frequency f is as stated in the equation (2). The corrected inching rate Ihab can be the corrected inching rate Iha outputted from the second modulation unit 37 during the last control cycle.

Iha=I×Δt/(Δt+τ)+Ihab×τ/(Δt+τ) (7)

Tha=I×2×π×f×Δt/(2×π×f×Δt+1)+Ihab/(2×π×f×Δt+1) (8)

The second modulation unit 37 supplies the inching rate I inputted from the inching rate setting unit 36 and the corrected inching rate Ihab during the last control cycle to the equation (7) or the equation (8) to obtain the corrected inching rate Iha during the current control cycle. Upon obtaining the corrected inching rate Iha, the second modulation unit 37 changes the cutoff frequency f according to whether the now control flag Fd is 1 or 0, i.e., whether the downward slope control is executed or not.

In the case of the now control flag Fd=0, i.e., in the case where the forklift 1 does not execute the downward slope control, the second modulation unit 37 causes the cutoff frequency f during the increase in the inching rate I to be smaller than the cutoff frequency f during the decrease in the inching rate I. With this control, the responsiveness of the inching rate I in the increase in the inching rate I due to the increase in the accelerator opening Aop becomes lower than the responsiveness of the inching rate I in the decrease in the inching rate I due to the decrease in the accelerator opening Aop. Therefore, the second modulation unit 37 can prevent the rapid acceleration of the forklift 1 due to the sharp increase in the inching rate I, when the forklift 1 switches to power driving due to the operator's pressing operation on the accelerator pedal 41a to cancel the downward slope control.

In the case of the now control flag Fd=1, i.e., in the case where the forklift 1 executes the downward slope control, the second modulation unit 37 causes the cutoff frequency f during the decrease in the inching rate I to be equal to the cutoff frequency f during the increase in the inching rate I, when the accelerator pedal 41a is released. In the present embodiment, the cutoff frequency f in this case is equal to the cutoff frequency f when the inching rate I decreases in the case of the now control flag Fd=0. With this control, the responsiveness of the inching rate I can be enhanced to prevent the increase in speed of the forklift 1 during the execution of the downward slope control by the forklift 1, either in the case where the inching rate I increases or in the case where the inching rate I decreases.

The second modulation unit 37 outputs the obtained corrected inching rate Iha to a target absorption torque calculating unit 38. The target absorption torque calculating unit 38 has a map M1 in which a characteristic line Mn of the target absorption torque Tm to the actual engine rotating speed Nr is set. The target absorption torque calculating unit 38 obtains a corrected characteristic line Mc by multiplying the characteristic line Mn by the inputted corrected inching rate Iha. The target absorption torque calculating unit 38 calculates the target absorption torque Tm corresponding to the actual engine rotating speed Nr detected by the engine rotation sensor 43 illustrated in FIG. 2 by using the corrected characteristic line Mc. The target absorption torque calculating unit 38 supplies the obtained target absorption torque Tm to a conversion unit 39.

The conversion unit 39 generates an absorption torque instruction Ic corresponding to the target absorption torque Tm inputted from the target absorption torque calculating unit 38, and outputs the generated absorption torque instruction Ic to the pump capacity setting unit 11 of the traveling hydraulic pump 10. The absorption torque instruction Ic is a signal (in the present embodiment, a current value) for causing the traveling hydraulic pump 10 to absorb the target absorption torque Tm. The absorption torque instruction Ic is outputted from the conversion unit 39 to the forward pump solenoid proportional control valve 12 and the reverse pump solenoid proportional control valve 13 in the pump capacity setting unit 11. The forward pump solenoid proportional control valve 12 and the reverse pump solenoid proportional control valve 13 operate the pump capacity control cylinder based on the inputted absorption torque instruction Ic to change the opening degree of the swash plate 10S in the traveling hydraulic pump 10.

The control device 30 illustrated in FIGS. 2 and 4 executes the downward slope control according to the present embodiment, when the forklift 1 generates deceleration force, e.g., when the forklift 1 travels down a slope. Therefore, the control device 30 can prevent the increase in speed when the forklift 1, which is a work vehicle including an HST, travels down a slope. In particular, the control device 30 can prevent the increase in speed of the forklift 1, which is traveling down a slope, against the intention of the operator on the forklift 1 to reduce the speed. Thus, the control device 30 can inhibit the motion of the forklift 1 unintended by the operator. A heavy weight forklift 1 is likely to increase its speed due to the gravity force while it is traveling down a slope, compared to a lightweight forklift 1. The downward slope control according to the present embodiment can suppress the increase in speed of a heavy weight forklift 1 while it is traveling down a slope, thus effective.

The control device 30 illustrated in FIGS. 2 and 4 determines whether the downward slope control is executed or not by using a discharging pressure of the operating oil supplied to the hydraulic motor 20 from the traveling hydraulic pump 10 and an inflow pressure of the operating oil flown into the traveling hydraulic pump 10 from the hydraulic motor 20. Thus, the control device 30 can determine whether the downward slope control is executed or not without using an inclination of a downward slope and the speed Vc of the forklift 1, thereby being capable of easily making the determination. The control device 30 also has an advantage of not requiring sensors for detecting a downward slope for the determination as to whether the downward slope control is executed or not.

<Control when Forklift 1 Stopping on Downward Slope Starts to Travel>

FIG. 8 is a state transition diagram illustrating a change in the state when the forklift 1 stopping on a downward slope starts to travel. FIG. 8 illustrates a state D, a state E, and a state F. The state D indicates that the forklift 1 stops on a downward slope SP by using the mechanical brake 9 illustrated in FIG. 1, the state E indicates that the forklift 1 releases the mechanical brake 9 on the downward slope SP, and the state F indicates that the operator of the forklift 1 presses the accelerator pedal 41a to start to accelerate the forklift 1 on the downward slope SP.

As indicated by the state D, when the operator of the forklift 1 presses the inching pedal 40a illustrated in FIG. 2, the forklift 1 stops on the downward slope SP by the braking force of the mechanical brake 9. The speed of the forklift 1 is 0. No pressure is generated on the operating oil in the main hydraulic circuit 100 illustrated in FIG. 2. Specifically, the pressure Pa at the A port 10A and the pressure Pb at the B port 10B in the traveling hydraulic pump 10 both become 0, when the charge pressure of the charge pump 15 is not considered.

The state E indicates that the mechanical brake 9 of the forklift 1 is released. Since the mechanical brake 9 is released, the hydraulic motor 20 has high pressure at the side where the operating oil is discharged due to the force generated by the weight of the forklift 1 and the gravity force, i.e., the force for allowing the forklift 1 to travel downward on the downward slope SP. In the state E, the back part of the forklift 1 faces downward of the downward slope SP, so that the A port 10A of the traveling hydraulic pump 10 becomes the side where the operating oil discharged from the hydraulic motor 20 is flown. Therefore, the pressure Pa at the A port 10A of the traveling hydraulic pump 10 becomes higher than the pressure Pb at the B port 10B (Pa>Pb). In this case, the accelerator pedal 41a illustrated in FIG. 2 is not pressed, specifically, the accelerator opening Aop is 0. Therefore, the forklift 1 starts to slide down the downward slope SP due to the leaked operating oil from the traveling hydraulic pump 10. The speed of the forklift 1 increases to V4 from 0.

When the forward/reverse lever switch 42 outputs a reverse direction, and Pa−Pct>Pb is established, in other words, when the above-mentioned condition (b) is established, the control device 30 starts the downward slope control. The speed retaining unit 33 illustrated in FIG. 4 retains the speed V4 at the point when the condition (b) is established as a retained speed Vh. The speed increasing amount calculating unit 34 obtains a speed increasing amount Vin from the retained speed Vh and the actual speed Vc of the forklift 1, and outputs the obtained amount to the inching rate setting unit 36. The inching rate setting unit 36 supplies the speed increasing amount Vin and the corrected accelerator opening Aoc to the table 50 illustrated in FIG. 7 to acquire the corresponding inching rate I, and outputs the acquired inching rate I to the second modulation unit 37. The second modulation unit 37 modulates the inching rate I acquired from the inching rate setting unit 36 to obtain the corrected inching rate Iha, and outputs the obtained rate. The control device 30 obtains target absorption torque Tm of the traveling hydraulic pump 10 by using the corrected inching rate Iha, and changes the tilt angle of the swash plate in the traveling hydraulic pump 10 so as to attain the obtained target absorption torque Tm.

In the present embodiment, the forklift 1 travels backward on the downward slope SP. Therefore, the control device 30 supplies a control signal for realizing the tilt angle of the swash plate to attain the obtained target absorption torque Tm to the reverse pump solenoid proportional control valve 13 illustrated in FIG. 2. The reverse pump solenoid proportional control valve 13 controls the opening degree of the swash plate 10S in the traveling hydraulic pump 10 by the control signal inputted from the control device 30.

The state F indicates that the operator of the forklift 1 presses the accelerator pedal 41a to increase the speed Vc of the forklift 1 traveling backward on the downward slope SP. When the accelerator pedal 41a is pressed, the swash plate 10S in the traveling hydraulic pump 10 is opened, so that the speed Vc of the forklift 1 increases. Since the speed increasing amount Vin also increases by the increase in the speed Vc during the downward slope control, the traveling hydraulic pump 10 is controlled by the inching rate I determined by the inching rate setting unit 36 from the speed increasing amount Vin and the accelerator opening Aop. As a result, the increasing amount in the speed Vc to the accelerator opening Aop decreases, whereby the rapid acceleration with an operator's excessive pressing operation on the accelerator pedal 41a can be suppressed.

When the operator of the forklift 1 presses the accelerator pedal 41a, the increase in the accelerator opening Aop is suppressed by the modulation by the first modulation unit 35, and the rapid increase in the inching rate I calculated on the table 50 in the inching rate setting unit 36 is suppressed. The inching rate I by the inching rate setting unit 36 immediately becomes 100%, when the now control flag Fd becomes 0 during the determination by the control start determination unit 31. However, the increase in the inching rate I is suppressed by the modulation by the second modulation unit 37. Consequently, the rapid acceleration of the forklift 1 is prevented.

<Control Example>

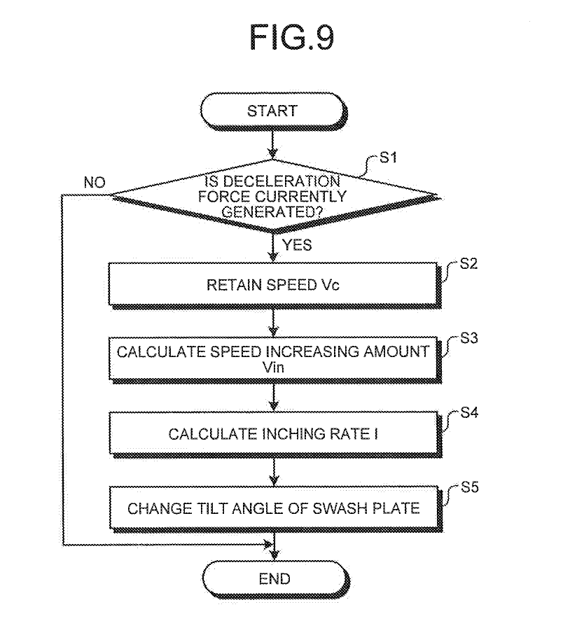

FIG. 9 is a flowchart illustrating one example of the downward slope control according to the present embodiment. In step S1, the control start determination unit 31 in the control device 30 illustrated in FIG. 4 determines whether the forklift 1 currently generates deceleration force or not. The control start determination unit 31 determines that the forklift 1 currently generates deceleration force when either one of the condition (a) and the condition (b) is established (Step S1, Yes), while it determines that the forklift 1 does not currently generate deceleration force when neither the condition (a) nor the condition (b) is established (Step S1, No). When the forklift 1 does not currently generate deceleration force (Step S1, No), the control start determination unit 31 outputs the now control flag Fd=0. Due to the now control flag Fd=0, the control device 30 does not execute the downward slope control.

When the forklift 1 currently generates deceleration force (step S1, Yes), the control start determination unit 31 outputs the now control flag Fd=1. In step S2, the speed retention determination unit 32 allows the speed retaining unit 33 to retain the speed Vc upon the establishment of the condition (a) or the condition (b) as the retained speed Vh, since the now control flag Fd is 1. In step S3, the speed increasing amount calculating unit 34 calculates the speed increasing amount Vin by using the actual speed Vc of the forklift 1 and the retained speed Vh. The actual speed Vc of the forklift 1 is detected by the speed sensor 46 illustrated in FIG. 1.

In step S4, the inching rate setting unit 36 calculates the inching rate I. The inching rate setting unit 36 supplies the speed increasing amount Vin acquired from the speed increasing amount calculating unit 34 and the accelerator opening Aop detected by the accelerator potentiometer 41 illustrated in FIG. 2 to the table 50 illustrated in FIG. 7 to obtain the corresponding inching rate I, and outputs the obtained inching rate I to the second modulation unit 37. The second modulation unit 37 modulates the inching rate acquired from the inching rate setting unit 36 to obtain a corrected inching rate, and outputs the resultant. In step S5, the control device 30 obtains target absorption torque Tm of the traveling hydraulic pump 10 by using the corrected inching rate Iha. The control device 30 changes the opening degree of the swash plate 10S in the traveling hydraulic pump 10 to change the tilt angle of the swash plate so as to attain the target absorption torque Tm acquired by using the corrected inching rate Iha. The control device 30 executes the downward slope control according to the present embodiment with the procedure described above.

Upon changing the tilt angle of the swash plate in the traveling hydraulic pump 10, the control device 30 supplies a control signal for realizing the tilt angle of the swash plate to attain the acquired target absorption torque Tm to the forward pump solenoid proportional control valve 12 illustrated in FIG. 2, when the forklift 1 travels in the forward direction. The forward pump solenoid proportional control valve 12 changes the opening degree of the swash plate 10S in the traveling hydraulic pump 10 by the control signal inputted from the control device 30. When the forklift 1 travels in the reverse direction, the control device 30 supplies a control signal for realizing the tilt angle of the swash plate to attain the acquired target absorption torque Tm to the reverse pump solenoid proportional control valve 13 illustrated in FIG. 2. The reverse pump solenoid proportional control valve 13 changes the opening degree of the swash plate 10S in the traveling hydraulic pump 10 by the control signal inputted from the control device 30.

<Modification>

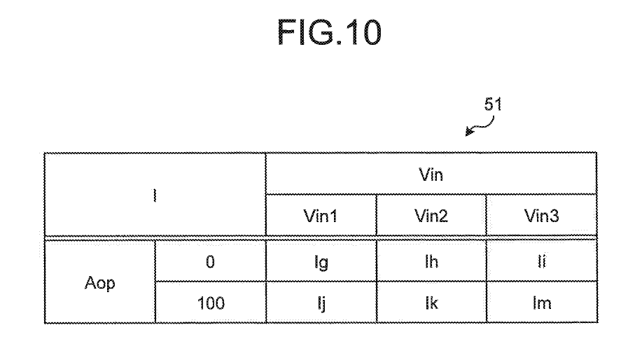

FIG. 10 is a conceptual diagram illustrating a table 51 in which an inching rate I is set according to the accelerator opening Aop and the speed increasing amount Vin. In the table 51, a different inching rate I is set with respect to the accelerator opening Aop and the speed increasing amount Vin same as those in the table 50 illustrated in FIG. 7. For example, the inching rate I set on the table 51 can be smaller than the inching rate I in the table 50. With this, the table 51 can generate a capacity ratio Rq greater than the table 50 on the traveling hydraulic pump 10 and the hydraulic motor 20 illustrated in FIG. 2. Therefore, the control device 30 can allow the traveling hydraulic pump 10 and the engine 4 to generate braking force greater than that generated with the table 50, by executing the downward slope control with the table 51.

The table 51 can suppress the increase in the speed Vc of a heavy weight forklift 1 traveling down a downward slope. For example, when the control device 30 illustrated in FIG. 2 is used for controls of plural types of forklifts 1, the table 50 and the table 51 may be stored in the storage unit 30M, and the processing unit 30C may select the table to be used depending on the weight of the forklift 1.

The control device 30 may obtain a mass of a cargo loaded on the fork 6 from the pressure of the operating oil in the lift cylinder 7 illustrated in FIG. 2, add the obtained mass to the weight of the forklift 1, and select the table to be used based on the total of the cargo mass and the weight. For example, when a cargo is empty or when a cargo is light, the control device 30 may execute the downward slope control by using the table 50, and when a cargo is heavy, the control device 30 may execute the downward slope control by using the table 51. With this control, the control device 30 can more appropriately suppress an increase in the speed Vc of the forklift 1 traveling down a downward slope, in consideration of the mass of the cargo on the forklift 1.

While a certain embodiment and modifications have been described, the above description is not intended to limit the scope of the present embodiment and the modifications. The components described above include those easily considered by a person skilled in the art, those substantially the same, and their equivalents. The above components can appropriately be combined.

Furthermore, various omissions, substitutions, or modifications may be made without departing from the spirit of the present embodiment and the modifications.

In the present embodiment and the modifications, the tilt angle of the swash plate in the traveling hydraulic pump 10 decreases to increase the capacity ratio Rq during the downward slope control. However, the capacity ratio Rq may be increased by increasing the tilt angle of the swash plate in the hydraulic motor 20. The capacity ratio Rq may also be increased by decreasing the tilt angle of the swash plate in the traveling hydraulic pump 10 and increasing the tilt angle of the swash plate in the hydraulic motor 20. In the present embodiment and the modifications, the work vehicle is the forklift 1. However, the work vehicle is not limited to the forklift 1, so long as it is a work vehicle having an HST and wheels. For example, the work vehicle may be a wheel loader.

### REFERENCE SIGNS LIST

1 FORKLIFT
2a DRIVE WHEEL
2b STEERING WHEEL
4 ENGINE
5 WORK MACHINE
6 FORK
9 MECHANICAL BRAKE
10 TRAVELING HYDRAULIC PUMP
10A A PORT
10B B PORT
10S SWASH PLATE
11 PUMP CAPACITY SETTING UNIT
20 HYDRAULIC MOTOR
20S SWASH PLATE
20a OUTPUT SHAFT
20b TRANSFER
21 MOTOR CAPACITY SETTING UNIT
30 CONTROL DEVICE
30C PROCESSING UNIT
30M STORAGE UNIT
31 CONTROL START DETERMINATION UNIT
32 SPEED RETENTION DETERMINATION UNIT
33 SPEED RETAINING UNIT
34 SPEED INCREASING AMOUNT CALCULATING UNIT
35 FIRST MODULATION UNIT
36 INCHING RATE SETTING UNIT
37 SECOND MODULATION UNIT
38 TARGET ABSORPTION TORQUE CALCULATING UNIT
39 CONVERSION UNIT
40 INCHING POTENTIOMETER
40a INCHING PEDAL (BRAKE PEDAL)
41 ACCELERATOR POTENTIOMETER
41a ACCELERATOR PEDAL
42 FORWARD/REVERSE LEVER SWITCH
42a FORWARD/REVERSE LEVER
43 ENGINE ROTATION SENSOR
46 SPEED SENSOR
47A, 47B PRESSURE SENSOR
50, 51 TABLE
100 MAIN HYDRAULIC CIRCUIT
Pa, Pb PRESSURE
Rq CAPACITY RATIO

1. A work vehicle including a work machine, the work vehicle comprising:
an engine;
a traveling hydraulic pump of a variable displacement type that is driven by the engine;
a hydraulic motor that forms a closed circuit with the traveling hydraulic pump and that is driven by operating oil discharged from the traveling hydraulic pump;
a drive wheel driven by the hydraulic motor; and
a control device that includes a determination unit determining whether or not an operator of the work vehicle has an intention of decelerating the work vehicle, and when the determination unit determines that the operator has an intention of decelerating the work vehicle and when the work vehicle starts to increase a speed of the work vehicle, the control device causes a capacity ratio, which is obtained by dividing a capacity of the hydraulic motor by a capacity of the traveling hydraulic pump, to be equal to or larger than a value at a point when the work vehicle starts to increase the speed of the work vehicle, according to an increasing amount in the speed of the work vehicle.

2. The work vehicle according to claim 1, wherein
the control device increases the capacity ratio, when the increasing amount of the speed of the work vehicle increases.

3. The work vehicle according to claim 1, further comprising:
an accelerator operation unit that increases or decreases a supply amount of fuel to the engine, wherein
when the increasing amount in the speed of the work vehicle is a same, the capacity ratio is increased as an operation amount on the accelerator operation unit is smaller.

4. The work vehicle according to claim 1, wherein
the control device determines whether or not the operator of the work vehicle has the intention of decelerating the work vehicle by using:
information indicating an advancing direction of the work vehicle selected by a selection switch used for switching a forward direction and a reverse direction of the work vehicle;
a discharging pressure of the operating oil supplied to the hydraulic motor from the traveling hydraulic pump; and
an inflow pressure of the operating oil flown into the traveling hydraulic pump from the hydraulic motor.

5. The work vehicle according to claim 1, wherein
the work vehicle is a forklift.

6. A control method for a work vehicle that includes a work machine, an engine, a traveling hydraulic pump of a variable displacement type that is driven by the engine, a hydraulic motor that forms a closed circuit with the traveling hydraulic pump and that is driven by operating oil discharged from the traveling hydraulic pump, and a drive wheel driven by the hydraulic motor, the control method comprising:
determining whether or not an operator of the work vehicle has an intention of decelerating the work vehicle; and
causing a capacity ratio, which is obtained by dividing a capacity of the hydraulic motor by a capacity of the traveling hydraulic pump, to be equal to or larger than a value at a point when the work vehicle starts to increase a speed of the work vehicle, according to an increasing amount in the speed of the work vehicle, when it is determined that the operator of the work vehicle has an intention of decelerating the work vehicle and when the work vehicle starts to increase the speed of the work vehicle, wherein
the capacity ratio is increased when the increasing amount in the speed increases, in case where an increasing amount in the capacity ratio is changed.

7. The control method for a work vehicle according to claim 6, wherein
the work vehicle includes an accelerator operation unit that increases or decreases a supply amount of fuel to the engine, wherein
when the increasing amount in the speed is a same, the capacity ratio is increased as an operation amount on the accelerator operation unit is smaller.

8. The control method for a work vehicle according to claim 6, wherein
whether or not the operator of the work vehicle has an intention of decelerating the work vehicle is determined by using:
information indicating an advancing direction of the work vehicle selected by a selection switch used for switching an advancing direction of the work vehicle;
a discharging pressure of the operating oil supplied to the hydraulic motor from the traveling hydraulic pump; and
an inflow pressure of the operating oil flown into the traveling hydraulic pump from the hydraulic motor.
